(19) United States
(12) Patent Application Publication
(10) Pub. No.: US 2006/0002430 A1
(43) Pub. Date: Jan. 5, 2006

(54) Slave device

(75) Inventor: Tai Yanazume, Kanagawa (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/149,269

(22) Filed: Jun. 10, 2005

(30) Foreign Application Priority Data
Jun. 14, 2004 (JP) P. 2004-175103

(51) Int. Cl. H04L 7/00; H04J 3/06

(52) U.S. Cl. 370/516; 375/354

(57) ABSTRACT

The slave device is connected to a master device via a data transfer bus and performs data transfer to/from the master device in accordance with an operation control signal controlled by the master device. The slave device comprises an automatic latch timing setting unit for generating a delay value corresponding to a latch timing used to latch data on the data transfer bus by measuring the time spent until the reference data transmitted from the master device on activation of the slave device is latched, and a latch timing adjustment unit for adjusting the latch timing of the operation control signal based on the delay value generated by the automatic latch timing setting unit.

### BACKGROUND OF THE INVENTION

1. Field of the Invention

The present invention relates to a slave device that performs data transfer to/from a master device connected via a data transfer bus.

2. Description of the Related Art

FIG. 9 is a schematic block diagram of a general interface system according to the related art used in case data transfers are performed between a master device and a slave device. As shown in FIG. 9, for a general inter-device interface according to the related art, a master device 901 such as a CPU finalizes the data on a data transfer bus and controls an operation control signal such as a write operation control signal to issue an operation instruction to a slave device 902 (for example a memory and a companion chip). The slave device 902 internally latches the data on the transfer bus in accordance with the instruction of the operation control signal thus accomplishing data transfer.

In the related art intra-device interface, the slave device 902 comprises an interface 903 and an internal circuit 904. For example, in case data transfer is made from the maser device 901 to the slave device 902, the data on the data transfer bus is latched using the operation control signal as a latch timing in an interface circuit 903 and the latched data is stored into the internal circuit 904 (for example, refer to JP11-341001 A).

For the master device 901 used in the related art inter-device inter face, a system that guarantees the data DATA, ADR on the data transfer bus on the rising edge of the operation control signal (CS, WE) shown in FIG. 10 and a system that guarantees the data DATA, ADR on the data transfer bus on the trailing edge of the operation control signal (CS, WE) shown in FIG. 11.

Thus, in order for the slave device 902 to correctly latch the data on the data transfer bus within a data guarantee period of the master device 901, the latch timing must be specified taking into consideration the system of the master device 901 in the design of the device.

In case the timing for controlling the operation control signal differs from the period when the data of the data transfer bus is guaranteed, the latch timing to correctly latch the data is different, even on a master device 901 of the same system.

In case a slave device 902 is specially ordered for development per master device 901, the latch timing has to be designed per master device 901. In case a single slave device 902 is used by a plurality of master device types, the slave device cannot be connected to the master device unless the period that the master device 901 guarantees the data on the data transfer bus 920 matches the timing that the slave device 902 latches the data. Thus, the latch timing of the slave device 902 is a major factor that lowers the versatility of the slave device 902.

### SUMMARY OF THE INVENTION

The invention has as an object to provide a slave device capable of enhancing the versatility of the slave device by arbitrarily changing the latch timing.

A slave device according to the invention is one that performs data transfer to/from a master device connected via a data transfer bus, comprising latch timing adjustment means for adjusting the timing used by the master device to latch the data on the data transfer bus based on an operation control signal for controlling the operation of the slave device and storage means for storing a parameter that delays the latch timing adjusted by the latch timing adjustment means by way of setting from the master device.

With this configuration, it is possible to arbitrarily change the latch timing by delaying the data latch timing by way of setting from the master device, which enhances the versatility of the slave device.

A slave device according to the invention is one that performs data transfer to/from a master device connected via a data transfer bus, comprising latch timing adjustment means for adjusting the timing used by the master device to latch the data on the data transfer bus based on an operation control signal for controlling the operation of the slave device and latch timing setting means for setting a parameter that delays the latch timing adjusted by the latch timing adjustment means based on the latch time of reference data measured on activation of the slave device.

With this configuration, it is possible to arbitrarily change the latch timing by delaying the latch timing based on the latch time of reference data measured on activation of the slave device, which enhances the versatility of the slave device.

According to the invention, the latch timing adjustment means comprises a first path for delaying the control signal via at least one flip-flop, a second path for bypassing the first path, and a selector for toggling between the first path and the second path.

With this configuration, it is possible to configure the latch timing adjustment means without using a decoder or a delay circuit, which reduces the cost of the slave device.

According to the invention, it is not necessary to design the interface for a slave device per master device connected, which enhances the versatility of the slave device.

### BRIEF DESCRIPTION OF THE DRAWINGS

FIG. 1 is a block diagram of an interface system for describing a first embodiment of the invention;

FIG. 2 shows a case where a latch timing is changed using the trailing edge of an operation control signal as a reference in the first embodiment of the invention;

FIG. 3 is a block diagram of an interface system for describing a second embodiment of the invention;

FIG. 4 shows an exemplary configuration of a latch timing adjustment unit according to the second embodiment;

FIG. 5 shows the configuration of a latch timing adjustment unit comprising flip-flops and a selector alone according to the second embodiment;

FIG. 6 is a block diagram of an automatic latch timing setting unit according to the second embodiment;

FIG. 7 is a block diagram of an automatic latch timing setting unit (8-bit data) according to the second embodiment;

FIG. 8 shows an automatic latch timing setting sequence in an interface system according to the second embodiment;

FIG. 9 shows the configuration of a general interface system according to the related art;

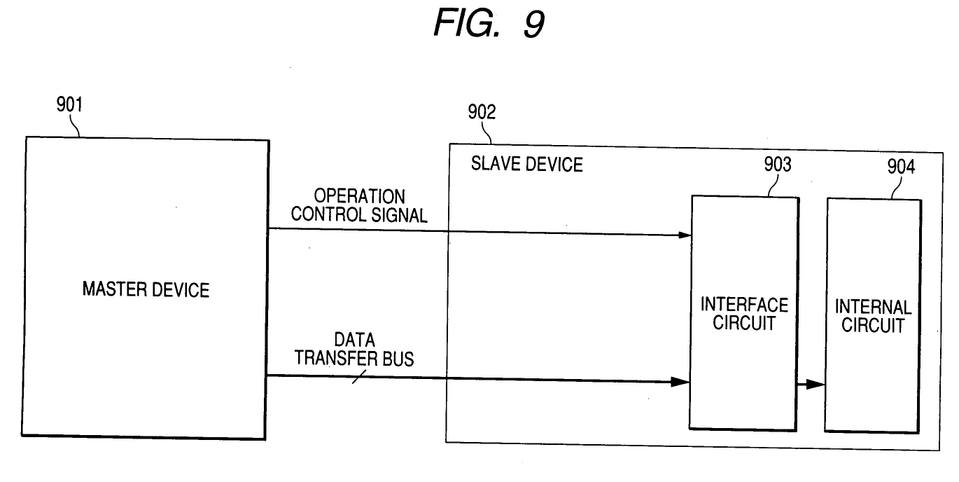

FIG. 10 shows a timing chart where data is latched on the rising edge of an operation control signal; and

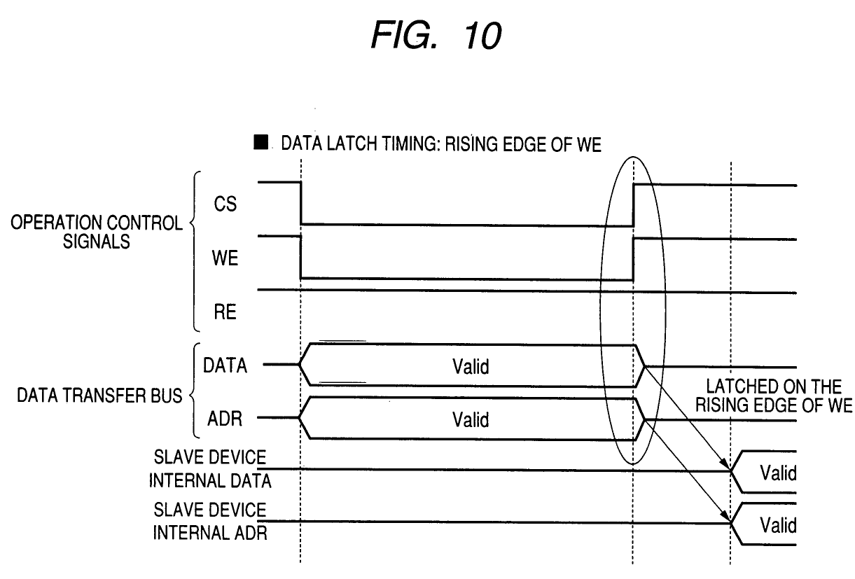

FIG. 11 shows a timing chart where data is latched on the trailing edge of an operation control signal.

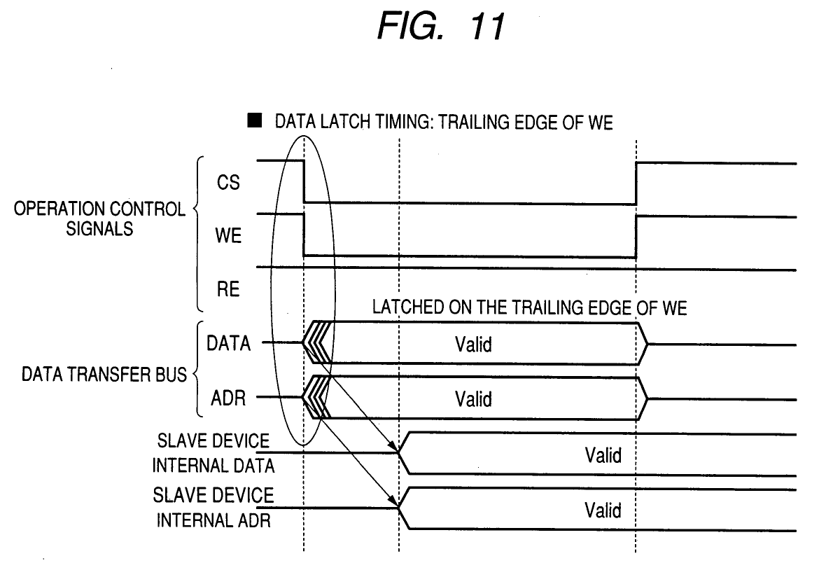

### DESCRIPTION OF THE PREFERRED EMBODIMENTS

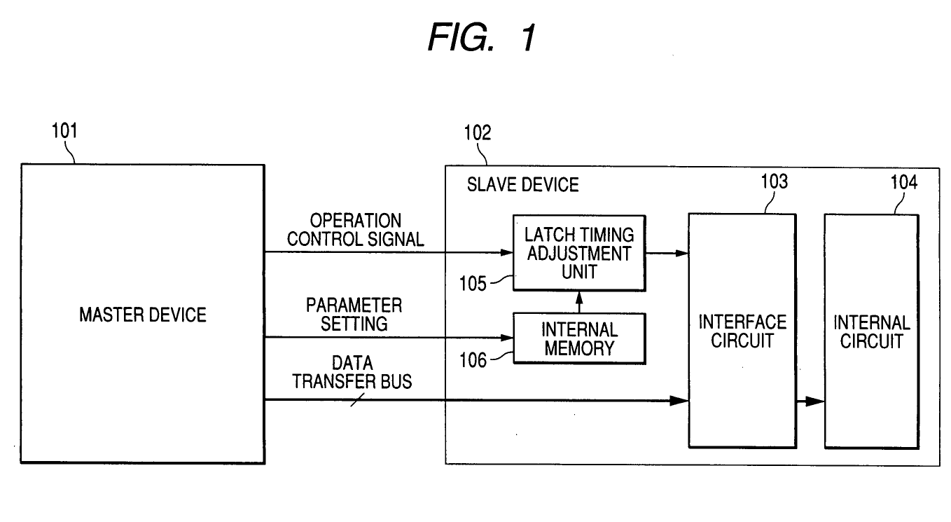

FIG. 1 is a block diagram of an interface system for describing a first embodiment of the invention. The interface system including a slave device of this embodiment comprises a master device 101 such as a CPU and a slave device 102 such as a memory and a companion chip. The slave device 102 comprises a latch timing adjustment unit 105, an internal memory 106, an interface circuit 103 and an internal circuit 104.

The latch timing adjustment unit 105 generates a latch timing used to latch data on a data transfer bus from an operation control signal such as a write operation control signal and a parameter stored in the internal memory 106 and communicates the latch timing to the interface circuit 103. In this practice, the parameter stored in the internal memory 106 is preset via a parameter setting signal. The interface circuit 103 latches the data on the data transfer bus and stores the data into the internal circuit 104.

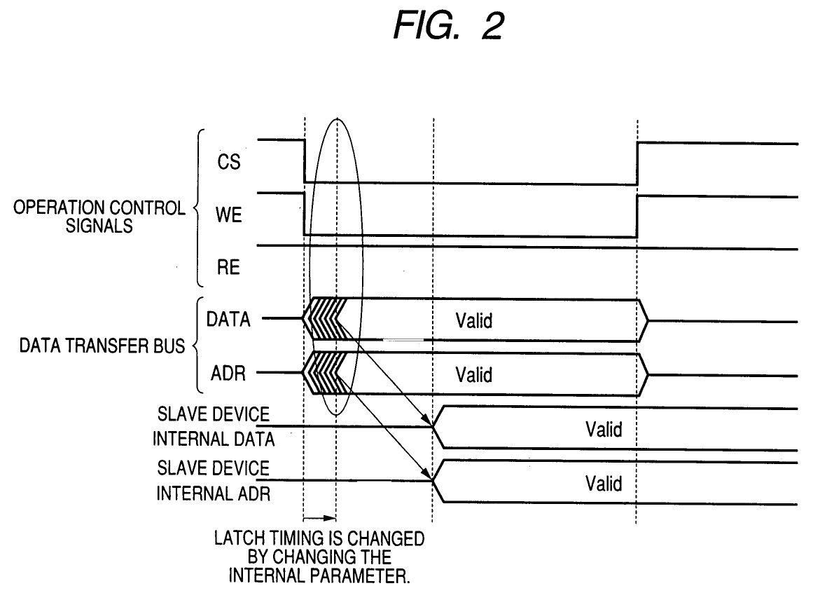

FIG. 2 shows a case where a latch timing is changed using the trailing edge of an operation control signal as a reference. As shown in FIG. 2, according to this embodiment, the latch timing is changed by changing the internal parameter stored in the internal memory 106, by using as a reference the trailing edge of an operation control signal CS, WE. This stably latches DATA, ADR on the data transfer bus and incorporate DATA and ADR into the internal circuit 104 of the slave device 102.

According to this embodiment, it is possible to set the latch timing of the slave device when the device is connected, not when the device is designed. This enhances the versatility of the slave device.

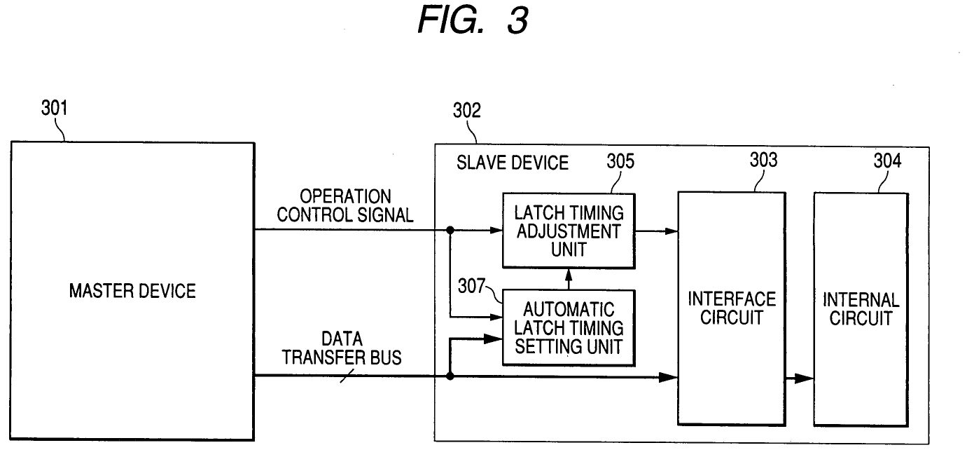

FIG. 3 is a block diagram of an interface system for describing a second embodiment of the invention. The interface system including a slave device of this embodiment comprises a master device 301 such as a CPU and a slave device 302 such as a memory and a companion chip. The slave device 302 comprises a latch timing adjustment unit 305, an automatic latch timing setting unit 307, an interface circuit 303, and an internal circuit 304.

The slave device 302 according to this embodiment automatically determines, by way of the automatic latch timing setting unit 307, the parameter for latch timing adjustment set in the internal memory 106 in Embodiment 1 The slave device 302 according to this embodiment is connected to the master device 301 via a data transfer bus and performs data transfer to/from the master device 301 in accordance with an operation control signal controlled by the master device 301. The slave device 302 comprises the automatic latch timing setting unit 307 for generating a delay value corresponding to a latch timing used to latch data on the data transfer bus by measuring the time spent until the reference data transmitted from the master device on activation of the slave device 302 is latched, and the latch timing adjustment unit 305 for adjusting the latch timing of the operation control signal based on the delay value generated by the automatic latch timing setting unit 307.

According to this embodiment, the time spent until the reference data transmitted from the master device on activation of the slave device 302 is latched is measured, the delay value corresponding to the latch timing used to latch data on the data transfer bus is generated, and the latch timing of the operation control signal is adjusted based on the delay value. This allows a system designer to design an interface with the access timing between the master device and the slave device being transparent to the designer.

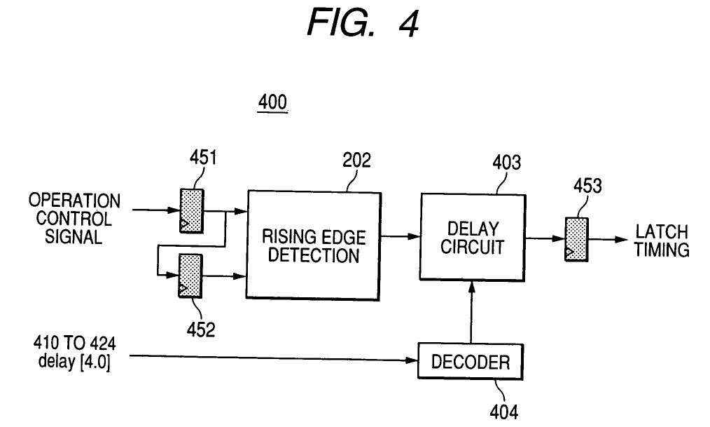

FIG. 4 shows an exemplary configuration of a latch timing adjustment unit according to this embodiment. As shown in FIG. 4, a latch timing adjustment unit 400 comprises a trailing edge detecting block 402 for detecting the edge of an operation control signal, a decoder 404 for decoding the setting of parameters 410 through 424, a delay circuit 403 for delaying the edge in accordance with the delay value decoded by the decoder 404, and flip-flops 451, 542, 453 for synchronizing the timings of the signals.

The latch timing adjustment unit 400 detects the edge of the operation control signal in the trailing edge detecting block 402 and delays the edge in accordance with the delay value obtained by decoding the setting of parameters 410 through 424, thereby adjusting the latch timing used to latch the operation control signal.

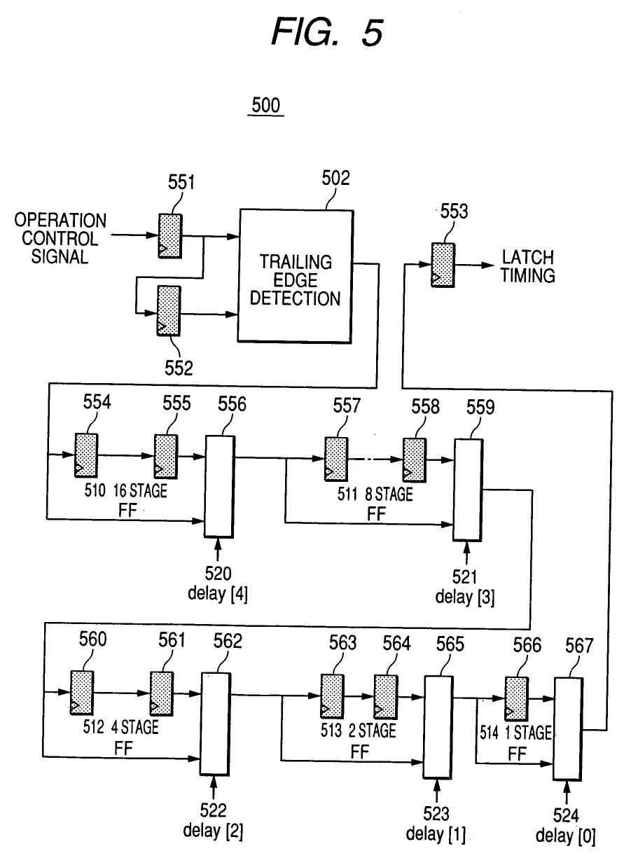

FIG. 5 shows a latch timing adjustment unit 500 comprising flip-flops and a selector that serves as the circuit of the latch timing adjustment unit 400. The latch timing adjustment unit 500 comprises, instead of the delay circuit 403 and the decoder 404 in FIG. 4, a 16-stage flip-flop 510 where flip-flops 554, 555 and the like are serially connected, a selector 556 for toggling between, by way of a selection signal, a signal path that passes through the 16-stage flip-flop 510 and a signal path that bypasses the 16-stage flip-flop 510, an 8-stage flip-flop 511 where flip-flops 557, 558 and the like are serially connected, a selector 559 for toggling between, by way of a selection signal, a signal path that passes through the 8-stage flip-flop 511 and a signal path that bypasses the 8-stage flip-flop 511, a 4-stage flip-flop 512 where flip-flops 560, 561 and the like are serially connected, a selector 562 for toggling between, by way of a selection signal, a signal path that passes through the 4-stage flip-flop 512 and a signal path that bypasses the 4-stage flip-flop 512, a 2-stage flip-flop 513 where flip-flops 563, 564 are serially connected, a selector 565 for toggling between, by way of a selection signal, a signal path that passes through the 2-stage flip-flop 513 and a signal path that bypasses the 2-stage flip-flop 513, a single-stage flip-flop 514 comprising a flip-flop 566, and a selector 567 for toggling between, by way of a selection signal, a signal path that passes through the single-stage flip-flop 514 and a signal path that bypasses the single-stage flip-flop 514.

The latch timing adjustment unit shown in FIG. 5 sets the delay time for a multistage flip-flop in association with each bit of the selection signal thereby configuring a simple timing adjustment unit without using a decoder or a delay circuit.

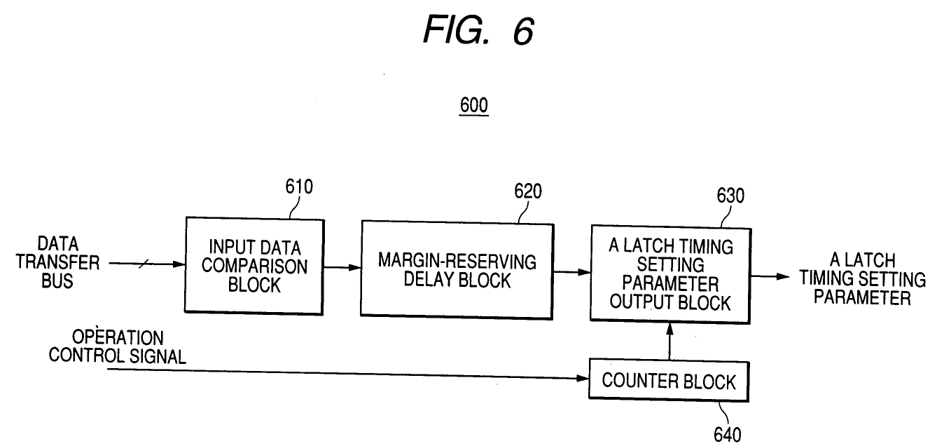

FIG. 6 shows an exemplary configuration of an automatic latch timing setting unit 600 according to this embodiment. The automatic latch timing setting unit 600 comprises an input data comparison block 610 to which a data transfer bus is connected, a margin-reserving delay block 620, a latch timing setting parameter output block (delay value output block) 630, and a counter block to which an operation control signal is input.

The input data comparison block 610 sequentially latches data on the data transfer bus and notifies the margin-reserving delay block 620 that data latch is enabled once predetermined data is latched. The margin-reserving delay block 620 delays the latch-enable timing in order to reserve a timing that allows stable latching of data and transmits a latch enable notice to the latch timing setting parameter output block 630. The latch timing setting parameter output block 630, receiving a latch enable notice from the margin-reserving delay block 620, reads the counter value of the counter block 640 and outputs the counter value as a latch timing setting parameter. The counter block 640 resets the edge of the operation control signal and is constantly engaged in counting while the automatic latch timing setting unit 307 is operating.

By way of the above operation, the automatic latch timing setting unit 307 measures the time spent until the data latched from the data transfer bus matches the predetermined data by using the operation control signal as a reference, and outputs the result as a latch timing setting parameter.

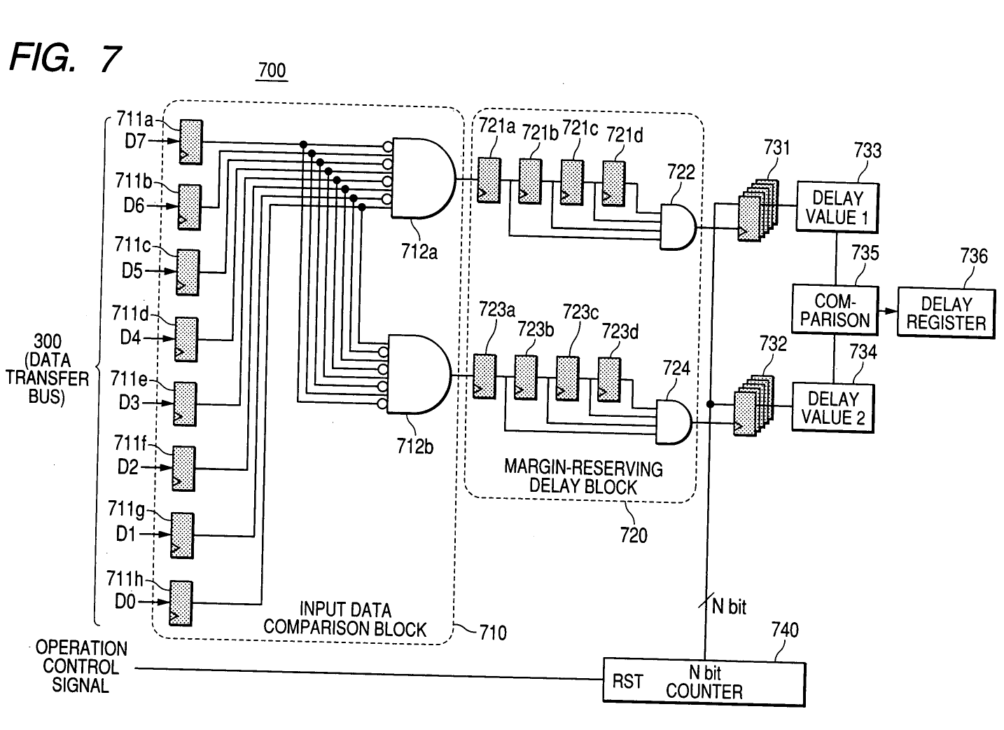

FIG. 7 shows an exemplary configuration of an automatic latch timing setting unit (8-bit data). In an automatic latch timing setting unit 700 of this embodiment, an input data comparison block 710 comprises flip-flops 711a through 711h for latching data supplied from the data transfer bus and AND circuits 712a, 712b that opens its gate once the flip-flops 711a through 711h have latched predetermined data. A margin-reserving delay block 720 comprises flip-flops 721a through 721d for delaying a latch enable timing, an AND circuit 722, flip-flops 723a through 723d, and an AND circuit 724.

A latch timing setting parameter output block 730 comprises flip-flops 731, 732, a delay value 1 register 733, a delay value 2 register 734, a comparator 735, and a delay register 736. The comparator 735 compares the value of the delay value 1 register 733 with the value of the delay value 2 register 734. In case the delay value 1 is smaller than the delay value 2, the comparator 735 stores the value of the delay value 2 register 734 into a delay register 336. In case the delay value 1 is equal to or greater than the delay value 2, the comparator 735 stores the value of the delay value 1 register 733 into a delay register 736. The data stored into the delay register 736 is output as a latch timing setting parameter 702.

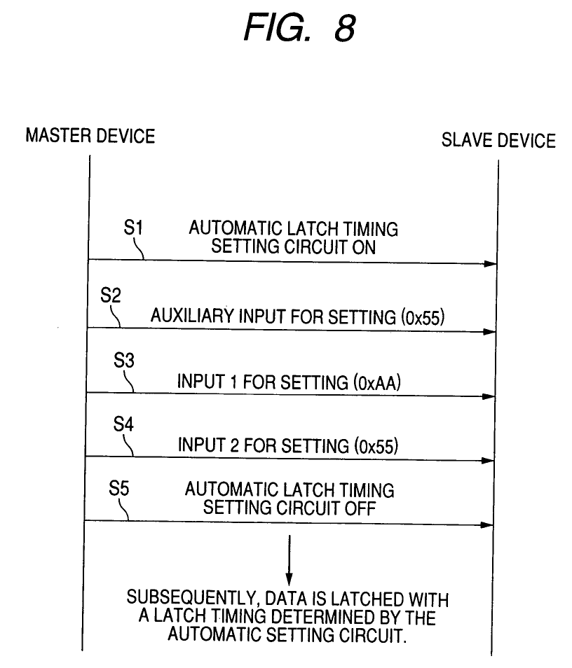

FIG. 8 shows an example of automatic latch timing setting sequence by way of the automatic latch timing setting unit 700. As shown in FIG. 8, in the automatic latch timing setting sequence, automatic latch timing setting circuit ON is noticed from the master device to the slave device (step S1). Next, an auxiliary input (0x55) for reservation of a margin is noticed (step S2). Then, an input 1 for setting (0xAA) (step S3), an input 2 for setting (0x55) (step S4), and automatic latch timing setting circuit OFF is noticed (step s5). Subsequently, data is latched with a latch timing determined by the automatic setting circuit.

According to this embodiment, the time spent until the reference data transmitted from the master device on activation of the slave device 302 is latched is measured, the delay value corresponding to the latch timing used to latch data on the data transfer bus is generated, and the latch timing of the operation control signal is adjusted based on the delay value. This allows a system designer to design an interface with the access timing between the master device and the slave device being transparent to the designer.

The slave device according to the invention employs an interface system that also supports an input from a master device of specifications where the data guarantee period of the operation control signal and data transfer bus is different from that for the slave device. This interface system is useful as an interface system for a versatile slave device (companion chip).

1. A slave device that performs data transfer to/from a master device connected via a data transfer bus, comprising:
a latch timing adjuster, adjusting the timing used by the master device to latch the data on the data transfer bus based on an operation control signal for controlling the operation of the slave device; and
a storage, storing a parameter that delays the latch timing adjusted by the latch timing adjuster by setting from the master device.

2. A slave device that performs data transfer to/from a master device connected via a data transfer bus, comprising
a latch timing adjuster, adjusting the timing used by the master device to latch the data on the data transfer bus based on an operation control signal for controlling the operation of the slave device; and
a latch timing setter, setting a parameter that delays the latch timing adjusted by the latch timing adjuster based on the latch time of reference data measured on activation of the slave device.

3. The slave device according to claim 1, wherein the latch timing adjuster comprises a first path for delaying the control signal via at least one flip-flop, a second path for bypassing the first path, and a selector for toggling between the first path and the second path.

4. The slave device according to claim 2, wherein the latch timing adjuster comprises a first path for delaying the control signal via at least one flip-flop, a second path for bypassing the first path, and a selector for toggling between the first path and the second path.
